(19) United States
(12) Patent Application Publication
(10) Pub. No.: US 2010/0178918 A1
(43) Pub. Date: Jul. 15, 2010

(54) Methods and Apparatus For Mobile Initiated Reselection In A Communication Network

(75) Inventor: Kanagarajan Chandrasekaran, Berkshire (GB)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/354,608

(22) Filed: Jan. 15, 2009

(51) Int. Cl. H04W 4/00; H04M 1/00; H04B 7/00

(52) U.S. Cl. 455/435.2; 455/550.1; 455/525

(57) ABSTRACT

Methods and apparatus for mobile initiated reselection in a communication network. In an aspect, a method includes establishing at least one of a temporary block flow (TBF) downlink and a TBF uplink with a first cell, determining that reselection to a second cell is to be performed, and transmitting a reselection status message to the first cell indicating the reselection. An apparatus includes transceiver logic to establish at least one of a TBF downlink and a TBF uplink with a first cell, and processing logic to determine that reselection to a second cell is to be performed, and to transmit a reselection status message to the first cell indicating the reselection. A method includes establishing at least one of a TBF downlink and a TBF uplink, receiving a reselection status message, and terminating at least one of the TBF downlink and uplink in response to the message.

### BACKGROUND

1. Field

The present application relates generally to the operation of wireless communication systems, and more particularly, to methods and apparatus for efficient mobile initiated reselection in a communication network.

2. Background

Wireless cellular telecommunication networks are now commonly known. In this regard, the area covered by a network is divided into cells. Each cell is provided with a base station. The base stations are configured to communicate with mobile stations (MS) or other user equipment (UE) located in their respective cells.

Various standards have been proposed for communication within the network. For example, one known standard is the GSM (global system for mobile communications) standard. This is primarily designed for speech. The GPRS (general packet radio service) standard has been proposed for data. The GPRS standard has generally been proposed in the context of the GSM standard. The GSM standard allows circuit switched communication while the GPRS standard allows packet switched communication.

When a mobile station moves, it can move from a location in one cell to a location in another cell. When that occurs, the mobile station will generally stop communicating with the base station associated with its previous cell and start communicating with a base station associated with its new cell. This is generally referred to as handover when the MS moves from one cell to another during a voice call and reselection when the MS moves in an idle state or in data transfer.

In the context of the GPRS standard, cell reselection procedures are specified. During cell reselection the mobile station changes the cell (and the base station) with which it is associated. Currently, three cell reselection procedures are utilized. In the first two procedures, referred to as NC0 and NC1, the mobile station makes the decision as to which cell the mobile station is to be associated. In the third procedure referred to as NC2, the network makes the decision as to the cell with which the mobile station is to be associated. As will be appreciated, if the cells are overlapping or if the mobile station is located in border regions, different decisions can be made in different circumstances as to the cell with which the mobile station is to be associated.

When a mobile station is in communication with a base station of a first cell, a temporary block flow (TBF) downlink is set up to carry transmitted data blocks to the mobile station. When the location of the mobile station changes, the mobile station decides to reselect to a second cell. This process is referred to as Autonomous Reselection and represents the NC0 mode of operation. This operation is also applicable to the NC1 mode in which the MS sends an indication of neighbor cell measurements but still decides where it wants to reselect. During NC0/NC1 reselection, the mobile station releases the TBF downlink abnormally and stops listening for the downlink data transmitted from the first cell so that it can establish communications with the second cell.

However, the first cell may not know the mobile station has reselected to the second cell and keeps sending downlink data blocks for a few more seconds. The transmission of these extra data blocks waste precious bandwidth. For example, the first cell will continue transmitting downlink data blocks until a timeout occurs. For example, a timeout may occur when the first cell does not receive any more data from the MS, which is usually an acknowledgement for the data transmitted to the MS.

In addition, a temporary flow identifier (TFI) is assigned to the TBF downlink for data transfer purposes. After the mobile reselects to another cell, this TFI cannot be reused by the first cell until the TBF downlink is released. Thus, during NC0/NC1 operation, TFI reused may be delayed. Furthermore, if the MS has a TBF uplink, the network will allocate an uplink status flag (USF) so that the MS can transmit blocks on the uplink. When the MS performs reselection, the network might continue to allocate USF because it would not know until a time out occurs that the MS has decided to reselect to another cell. In addition, an uplink TFI is assigned to the TBF uplink. The uplink TFI cannot be reused until the TBF uplink is released. Again, mobile reselection may cause uplink TFI reuse to be delayed.

Therefore, what is needed is a mechanism that operates to overcome the deficiencies associated with conventional systems to provide efficient use of air interface resources when a MS initiates reselection in a communication network.

### SUMMARY

In one or more aspects, a reselection system, comprising methods and apparatus, is provided that operates to provide efficient use of air interface resources when a mobile station initiates reselection in a communication network. In an aspect, the system operates to allow a mobile station to send a status message indicating that it is going to reselect to a different cell. This allows the network to save precious bandwidth by immediately releasing a current TBF downlink and stopping the transmission of downlink data blocks. A current TBF uplink is also released. Since the TBF downlink and TBF uplink are immediately released, faster TFI re-use is also possible.

In an aspect, a method is provided for reselection in a communication network. The method comprises establishing at least one of a TBF downlink and a TBF uplink with a first cell, determining that reselection to a second cell is to be performed, and transmitting a reselection status message to the first cell indicating the reselection.

In an aspect, an apparatus is provided for reselection in a communication network. The apparatus comprises transceiver logic configured to establish at least one of a TBF downlink and a TBF uplink with a first cell, and processing logic configured to determine that reselection to a second cell is to be performed, and transmit a reselection status message to the first cell indicating the reselection.

In an aspect, an apparatus is provided for reselection in a communication network. The apparatus comprises means for establishing at least one of a TBF downlink and a TBF uplink with a first cell, means for determining that reselection to a second cell is to be performed, and means for transmitting a reselection status message to the first cell indicating the reselection.

In an aspect, a method is provided for reselection in a communication network. The method comprises establishing at least one of a TBF downlink and a TBF uplink, receiving a reselection status message, and terminating at least one of the TBF downlink and the TBF uplink in response to the reselection message.

In an aspect, an apparatus is provided for reselection in a communication network. The apparatus comprises a transceiver configured to establish at least one of a TBF downlink and a TBF uplink with a device, and processing logic configured to receive a reselection status message, and terminate at least one of the TBF downlink and the TBF uplink in response to the reselection message.

In an aspect, an apparatus is provided for reselection in a communication network. The apparatus comprises means for establishing at least one of a TBF downlink and a TBF uplink with a device, means for receiving a reselection status message, and means for terminating at least one of the TBF downlink and the TBF uplink in response to the reselection message.

Other aspects will become apparent after review of the hereinafter set forth Brief Description of the Drawings, Description, and the Claims.

### BRIEF DESCRIPTION OF THE DRAWINGS

The foregoing aspects described herein will become more readily apparent by reference to the following Description when taken in conjunction with the accompanying drawings wherein:

FIG. 1 shows an exemplary communication network that illustrates aspects of a reselection system;

FIG. 2 shows exemplary reselection logic for use in aspects of a reselection system;

FIG. 3 shows an exemplary method for use in aspects of a reselection system;

FIG. 4 shows exemplary channel logic for use in aspects of a reselection system;

FIG. 5 shows an exemplary method for use in aspects of a reselection system;

FIG. 6 shows exemplary reselection logic for use in aspects of a reselection system; and

FIG. 7 shows exemplary channel logic for use in aspects of a reselection system.

### DESCRIPTION

The following description describes aspects of a reselection system that operate to provide for efficient reselection in a communication network. For example, the system operates to allow a mobile station to send a status message indicating that it is going to reselect to a different cell. This allows the network to save precious bandwidth by immediately releasing the current TBF downlink and/or TBF uplink and stopping the transmission of downlink and/or uplink data blocks. Since the TBF downlink and/or TBF uplink are immediately released, faster TFI re-use is also possible.

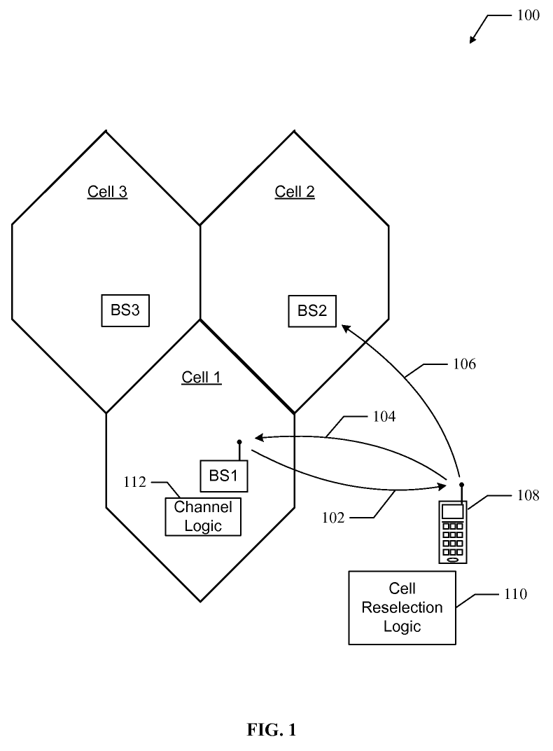

FIG. 1 shows a network 100 that illustrates aspects of a reselection system. The network 100 comprises three cells, namely: Cell1, Cell2, and Cell3. Each of the cells includes a base station (BS) for communicating with devices. The network 100 also comprises a device 108. The device 108 comprises a mobile telephone, PDA, notebook computer, pager, email device, or any other type of device that is operable to communicate with the network 100.

It should be noted that aspects of the reselection system are suitable for use with virtually any number of devices that communicate with the network 100 using any suitable wireless communication links. For the purpose of this description, the operation of the device 108 will be described in detail; however aspects of the reselection system are equally applicable to any number and/or types of devices operable to communicate with the network 100.

It will be assumed that the device 108 is currently within range to communicate with BS1 of Cell1. The BS1 comprises channel logic 112, which operates to establish a TBF downlink 102 to carry transmitted data blocks from BS1 to the device 108. For example, the TBF downlink 102 may be a downlink PDTCH channel in GPRS system. As part of the communication protocol, the channel logic 112 also assigns a TFI to the TBF downlink 102.

As the device 108 moves into the region of Cell2, cell reselection logic 110 at the device 108 determines that it would be desirable to perform a reselection to Cell2. Instead of abnormally terminating the TBF downlink 102, the cell reselection logic 110 operates to transmit a reselection status message to BS1 using an uplink communication link 104 that comprises a packet associated control channel (PACCH). In another aspect, the communication link 104 comprises a TBF uplink, in which case the device 108 will send the reselection status message over this uplink. In an aspect, the reselection status message comprises a packet TBF release message that is transmitted from the device 108. The reselection status message notifies BS1 that the device 108 will be performing a reselection to another cell. The device 108 then proceeds to establish communication with BS2 of Cell2.

Upon receipt of the reselection status message, the channel logic 112 of BS1 operates to terminate the TBF downlink 102 and/or the TBF uplink, and further to release associated TFIs so that they may be reassigned. Therefore, the reselection status message transmitted on the communication uplink 104 operates to save bandwidth by allowing the channel logic 112 to immediately terminate the TBF downlink 102 and/or the TBF uplink in response to the message. In addition, the channel logic 112 is able to release the assigned TFI(s) thereby making the TFI(s) available for quick reassignment.

Thus, a reselection system is provided that operates to provide for fast and efficient reselection in a communication network. It should be noted that the aspects illustrated in network 100 represent just one implementation and that other implementations are possible.

FIG. 2 shows exemplary cell reselection logic 200 for use in aspects of a reselection system. For example, the cell reselection logic 200 is suitable for use as the cell reselection logic 110 shown in FIG. 1. The cell reselection logic 200 comprises processing logic 202 and transceiver logic 204, which are coupled to a data bus 206. It should be noted that the cell reselection logic 200 illustrates just one implementation and that other implementations are possible within the scope of the aspects. Thus, in various aspects, the cell reselection logic 200 is suitable for use at a mobile device to perform cell reselections.

The transceiver logic 204 comprises hardware and/or hardware executing software that is configured to allow the cell reselection logic 200 to communicate data or other information over a network with remote devices or systems. In an aspect, the transceiver logic 204 is configured to establish a TBF downlink 208 with a communication network. For example, the TBF downlink 208 allows the cell reselection logic 200 to receive data and/or other information from the communication network. The transceiver logic 204 is also configured to establish a communication link 210 which comprises a PACCH or a TBF uplink with the communication network. If the communication link 210 is a TBF uplink, this TBF uplink may be used to send data blocks to the communication network, and the communication network may assign a TFI to this uplink. The communication link 210 allows the cell reselection logic 200 to transmit status messages to the communication network.

In one or more aspects, the processing logic 202 comprises at least one of a CPU, processor, gate array, hardware logic, memory elements, virtual machine, and/or hardware executing software. Thus, the processing logic 202 comprises logic to execute machine-readable instructions and to control one or more other functional elements of the reselection logic 200.

During operation, the processing logic 202 operates to control the transceiver logic 204 to establish the TBF downlink 208 with a first cell in a communication network. Once the TBF downlink 208 is established, the cell reselection logic 200 is able to receive transmitted data blocks from the network. The processing logic 202 also operates to control the transceiver logic 204 to establish the communication link 210 with the first cell in the communication network. If the communication link 210 is a TBF uplink, the cell reselection logic 200 is able to transmit data blocks to the network. The processing logic 202 then operates to determine when a reselection to a different cell is necessary. For example, the processing logic 202 may receive cell signal strength indicators from the transceiver logic 204 and use these indicators to determine when a reselection to a different network cell is necessary.

If the processing logic 202 determines that cell reselection is necessary, the processing logic 202 generates a reselection status message that is passed to the transceiver logic 204 for transmission over the communication link 210. The reselection status message communicates to the current cell that a reselection to a different cell is about to occur. Once the reselection begins, any additional data transmitted by the original cell on the TBF downlink 208 is ignored.

The processing logic 202 controls the transceiver logic 204 to establish communications with the new cell. For example, a new uplink TBF is established in the new cell to transmit cell update, data or routing area update messages. In response to the reselection status message, the original cell is able to terminate transmissions on the TBF downlink to save valuable bandwidth, and to allow quick reassignment of the associated TFI. In addition, if the communication link 210 is a TBF uplink, quick reassignment of its associated TFI is also possible.

In an aspect, the reselection system comprises a computer program product having one or more program instructions (“instructions”) or sets of “codes” stored or embodied on a machine-readable medium. When the codes are executed by at least one processor, for instance, a processor at the processing logic 202, their execution causes the processor to provide the functions of the reselection system described herein. For example, the machine-readable medium comprises a floppy disk, CDROM, memory card, FLASH memory device, RAM, ROM, or any other type of memory device or machine-readable medium that interfaces to the cell reselection logic 200. In another aspect, the sets of codes may be downloaded into the cell reselection logic 200 from an external device or communication network resource. The sets of codes, when executed, will cause the cell reselection logic 200 to provide aspects of a reselection system as described herein.

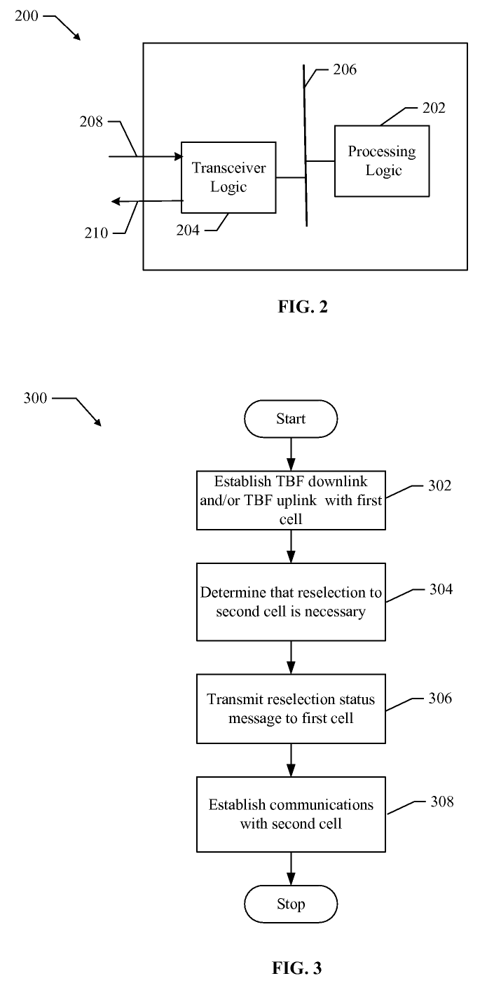

FIG. 3 shows an exemplary method 300 for use in aspects of a reselection system. For clarity, the method 300 is described below with reference to the cell reselection logic 200 shown in FIG. 2. In an aspect, the processing logic 202 executes one or more sets of codes to control the cell reselection logic 200 to perform the functions described below.

At block 302, communications are established with a network. For example, a TBF downlink and/or a TBF uplink are established that enables data to be transmitted between a first cell of a communication network and a mobile station. For example, the transceiver logic 204 operates to establish the TBF downlink and/or TBF uplink with the network cell.

At block 304, a determination is made that reselection to a new network cell is necessary. For example, reselection may be necessary based signal strength criteria associated with the current network cell. For example, the signal strength of the current cell may be fading and the new network cell provides sufficient signal strength to allow communications with the network to continue. In an aspect, the processing logic 202 makes this determination.

At block 306, a reselection status message is transmitted to the original network cell. The reselection status message indicates that a reselection to a new network cell is to be performed. In an aspect, the processing logic 202 generates the reselection status message and passes it to the transceiver logic 204. The transceiver logic 204 transmits the reselection status message to the original network cell using a communication link that may be a PACCH or a TBF uplink. For example, the reselection status message is transmitted over the communication link 210. The reselection status message may be formatted in any suitable format and encoded or encrypted using any suitable encoding or encrypting technique.

In an aspect, the reception of the reselection status message operates as a trigger in the network side to stop transmitting downlink TBF data immediately and re-use the associated TFI for another mobile station. In another aspect, the reception of the reselection status message operates as a trigger to notify an associated SGSN to not to send data to the BSS of the cell originally associated with the MS before the reselection. In another aspect, if a TBF uplink was established, the reselection status message operates as a trigger in the network side to signal that the associated TFI may be re-assigned.

At block 308, communication with a new network cell is established. For example, the transceiver logic 204 establishes a new uplink TBF to send uplink data if available or cell updates and/or routing area update messages. For example, these messages indicate to the network the cell location to where the mobile station has reselected. In response, the network may re-queue data to be sent to the mobile in a newly established downlink associated with the new network cell. Since the original network cell was notified of the reselection, it is able to save bandwidth by terminating the TBF downlink and/or TBF uplink. This also allows the associated TFI(s) to be quickly reassigned.

Therefore, the method 300 operates to provide for efficient reselection in a communication network. It should be noted that the method 300 is just one implementation and that the operations of the method 300 may be rearranged or otherwise modified within the scope of the various aspects. Thus, other implementations are possible with the scope of the various aspects described herein.

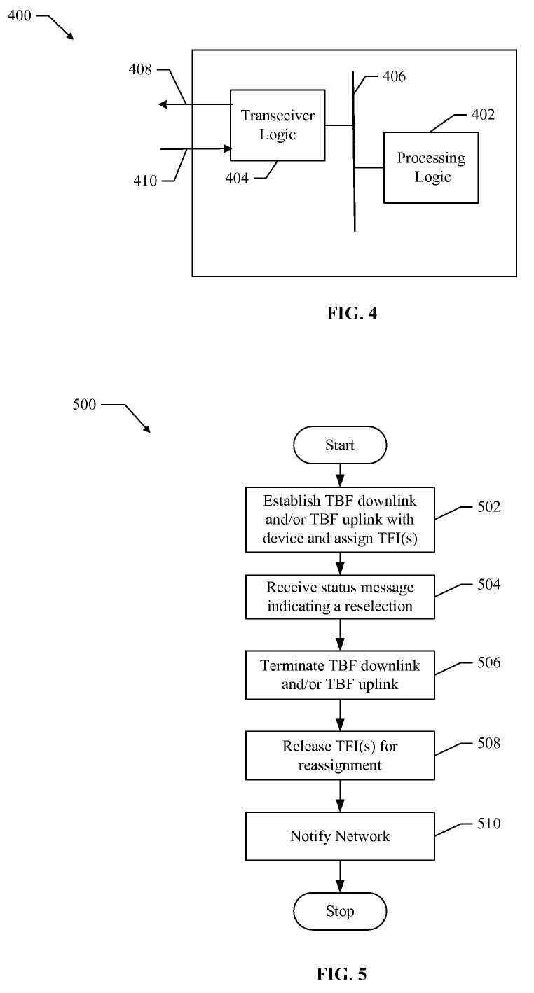

FIG. 4 shows exemplary channel logic 400 for use in aspects of a reselection system. For example, the channel logic 400 is suitable for use as the channel logic 112 shown in FIG. 1. The channel logic 400 comprises processing logic 402 and transceiver logic 404, which are coupled to a data bus 406. It should be noted that the channel logic 400 illustrates just one implementation and that other implementations are possible within the scope of the aspects. Thus, in various aspects, the channel logic 400 is suitable for use at a network cell to process mobile device reselections.

The transceiver logic 404 comprises hardware and/or hardware executing software that is configured to allow the channel logic 400 to communicate data or other information over a network with remote devices or systems. In an aspect, the transceiver logic 404 is configured to establish a TBF downlink 408 with a device on a communication network. For example, the TBF downlink 408 allows the channel logic 400 to transmit data and/or other information over the communication network to the device. The transceiver logic 404 is also configured to establish an uplink communication link 410 with the device. In an aspect, the uplink communication link is a PACCH or a TBF uplink. The uplink communication link 410 allows the channel logic 400 to receive data and status messages from the device, which are passed to the processing logic 402.

In one or more aspects, the processing logic 402 comprises at least one of a CPU, processor, gate array, hardware logic, memory elements, and/or hardware executing software. Thus, the processing logic 402 comprises logic to execute machine-readable instructions and to control one or more other functional elements of the channel logic 400.

During operation, the processing logic 402 operates to control the transceiver logic 404 to establish the TBF downlink 408 with a mobile station on a communication network. As part of establishing the TBF downlink 408, the processing logic 402 also assigns a TFI to uniquely identify the MS associated with the TBF downlink 408. For example, in FIG. 1, the BS1 assigns a unique TFI to identify the device 108. Once the TBF downlink 408 is established, the channel logic 400 is able to transmit data blocks to the device. In addition, the processing logic 402 operates to control the transceiver logic 404 to establish the communication link 410 which comprises a PACCH or a TBF uplink with a mobile station on a communication network. As part of establishing the TBF uplink 410, the processing logic 402 also assigns a TFI to uniquely identify the MS associated with the TBF uplink 410. For example, in FIG. 1, the BS1 assigns a unique TFI to identify the device 108. Once the TBF uplink 410 is established, the channel logic 400 is able to receive data blocks from the device.

At some point in time, the transceiver logic 404 may receive a reselection status message from the device over the PACCH or TBF uplink 410. The reselection status message indicates that the device has decided to perform a reselection to a different network cell.

In response to the reselection status message, the processing logic 402 operates to control the transceiver logic 404 to immediately terminate the TBF downlink 408 and/or the TBF uplink 410. This saves bandwidth since the transceiver logic 404 will no longer transmit additional data on the TBF downlink 408. Any such additional data will no longer be received by the device. In addition, the processing logic 402 operates to release the TFI assignments to the TBF downlink 408 and/or the TBF uplink 410 so that these TFI(s) can be quickly reassigned. In another aspect, the processing logic 402 notifies one or more other network entities of the termination of the TBF downlink and/or the TBF uplink so that data intended to be transmitted to or received from the mobile station can be re-routed or re-queued at a different cell site.

In an aspect, the reselection system comprises a computer program product having one or more program instructions (“instructions”) or sets of “codes” stored or embodied on a machine-readable medium. When the codes are executed by at least one processor, for instance, a processor at the processing logic 402, their execution causes the processor to provide the functions of the reselection system described herein. For example, the machine-readable medium comprises a floppy disk, CDROM, memory card, FLASH memory device, RAM, ROM, or any other type of memory device or machine-readable medium that interfaces to the channel logic 400. In another aspect, the sets of codes may be downloaded into the channel logic 400 from an external device or communication network resource. The sets of codes, when executed, cause the channel logic 400 to provide aspects of a reselection system as described herein.

FIG. 5 shows an exemplary method 500 for use in aspects of a reselection system. For clarity, the method 500 is described below with reference to the channel logic 400 shown in FIG. 4. In an aspect, the processing logic 402 executes one or more sets of codes to control the channel logic 400 to perform the functions described below.

At block 502, a TBF downlink and/or a TBF uplink are established with a device and TFI(s) are assigned. In an aspect, the processing logic 402 operates to control the transceiver logic 404 to establish the TBF downlink and/or the TBF uplink. The processing logic 402 also assigned the TFI(s). Once the downlink is established, data blocks can be transmitted to the device, and when the uplink is established, data blocks or other information can be received from the device.

At block 504, a reselection status message is received indicating that the device will perform a reselection to a different network cell. In an aspect, the reselection status message is received over the TBF uplink 410 or a PACCH.

At block 506, the TBF downlink and/or TBF uplink are terminated in response to the received reselection status message. In an aspect, the processing logic 402 controls the transceiver logic 404 to immediately terminate the TBF downlink 408 and/or the TBF uplink 410. This will save valuable bandwidth since additional data will not be transmitted

At block 508, the TFI(s) associated with the terminated TBF downlink and/or TBF uplink are released for reassignment. In an aspect, the processing logic 402 operates to release the TFI(s) and to assign them to a different TBF downlink and/or TBF uplink.

At block 510, the network is notified of the device reselection. In an aspect, the processing logic 402 operates to notify the network so that data intended for delivery to or reception from the device can be rerouted and/or re-queued at a different cell site.

Therefore, the method 500 operates to provide for efficient reselection in a communication network. It should be noted that the method 500 is just one implementation and that the operations of the method 500 may be rearranged or otherwise modified within the scope of the various aspects. Thus, other implementations are possible with the scope of the various aspects described herein.

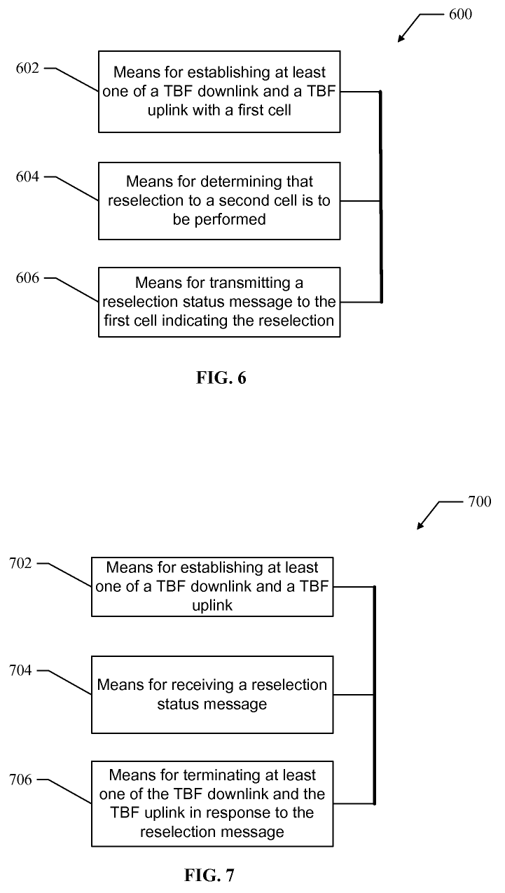

FIG. 6 shows exemplary reselection logic 600 for use in aspects of a reselection system. For example, the reselection logic 600 is suitable for use as the cell reselection logic 110 shown in FIG. 1. In an aspect, the reselection logic 600 is implemented by at least one integrated circuit comprising one or more modules configured to provide aspects of a reselection system as described herein. For example, in an aspect, each module comprises hardware and/or hardware executing software.

In an aspect, the reselection logic 600 comprises a first module comprising means (602) for establishing at least one of a TBF downlink and a TBF uplink with a first cell, which in an aspect comprises the transceiver logic 204. The reselection logic 600 also comprises a second module comprising means (604) for determining that reselection to a second cell is to be performed, which in an aspect comprises processing logic 202. The reselection logic 600 also comprises a third module comprising means (606) for transmitting a reselection status message to the first cell indicating the reselection, which in an aspect comprises the processing logic 202.

FIG. 7 shows exemplary channel logic 700 for use in aspects of a reselection system. For example, the channel logic 700 is suitable for use as the channel logic 112 shown in FIG. 1. In an aspect, the channel logic 700 is implemented by at least one integrated circuit comprising one or more modules configured to provide aspects of a reselection system as described herein. For example, in an aspect, each module comprises hardware and/or hardware executing software.

The channel logic 700 comprises a first module comprising means (702) for establishing at least one of a TBF downlink and a TBF uplink, which in an aspect comprises transceiver logic 404. The channel logic 700 also comprises a second module comprising means (704) for receiving a reselection status message, which in an aspect comprises transceiver logic 404. The channel logic 700 also comprises a third module comprising means (706) for terminating at least one of the TBF downlink and the TBF uplink in response to the reselection message, which in an aspect comprises the processing logic 402.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a wireless communication device. In the alternative, the processor and the storage medium may reside as discrete components in a wireless communication device.

The description of the disclosed aspects is provided to enable any person skilled in the art to make or use the present invention. Various modifications to these aspects may be readily apparent to those skilled in the art, and the generic principles defined herein may be applied to other aspects, e.g., in an instant messaging service or any general wireless data communication applications, without departing from the spirit or scope of the invention. Thus, the present invention is not intended to be limited to the aspects shown herein but is to be accorded the widest scope consistent with the principles and novel features disclosed herein. The word “exemplary” is used exclusively herein to mean “serving as an example, instance, or illustration.” Any aspect described herein as “exemplary” is not necessarily to be construed as preferred or advantageous over other aspects.

Accordingly, while aspects of a reselection system have been illustrated and described herein, it will be appreciated that various changes can be made to the aspects without departing from their spirit or essential characteristics. Therefore, the disclosures and descriptions herein are intended to be illustrative, but not limiting, of the scope of the invention, which is set forth in the following claims.

What is claimed is:

1. A method for providing reselection in a communication network, the method comprising:
establishing at least one of a temporary block flow (TBF) downlink and a TBF uplink with a first cell;
determining that reselection to a second cell is to be performed; and
transmitting a reselection status message to the first cell indicating the reselection.

2. The method of claim 1, wherein said transmitting comprises transmitting the reselection status message on at least one of an uplink packet associated control channel (PACCH) and the TBF uplink.

3. The method of claim 1, further comprising receiving data blocks over the TBF downlink.

4. The method of claim 1, wherein said determining comprises determining that the reselection is to be performed based on signal strength criteria.

5. The method of claim 1, wherein said reselection status message comprises a packet TBF release message.

6. An apparatus for providing reselection in a communication network, the apparatus comprising:
transceiver logic configured to establish at least one of a temporary block flow (TBF) downlink and a TBF uplink with a first cell; and
processing logic configured to determine that reselection to a second cell is to be performed, and transmit a reselection status message to the first cell indicating the reselection.

7. The apparatus of claim 6, wherein said processing logic is configured to transmit the reselection status message on at least one of an uplink packet associated control channel (PACCH) and the TBF uplink.

8. The apparatus of claim 6, wherein said transceiver logic is configured to receive data blocks over the TBF downlink.

9. The apparatus of claim 6, wherein said processing logic id configured to determine that the reselection is to be performed based on signal strength criteria.

10. The apparatus of claim 6, wherein said reselection status message comprises a packet TBF release message.

11. An apparatus for providing reselection in a communication network, the apparatus comprising:
means for establishing at least one of a temporary block flow (TBF) downlink and a TBF uplink with a first cell;
means for determining that reselection to a second cell is to be performed; and
means for transmitting a reselection status message to the first cell indicating the reselection.

12. The apparatus of claim 11, wherein said means for transmitting comprises means for transmitting the reselection status message on at least one of an uplink packet associated control channel (PACCH) and the TBF uplink.

13. The apparatus of claim 11, further comprising means for receiving data blocks over the TBF downlink.

14. The apparatus of claim 11, wherein said means for determining comprises means for determining that the reselection is to be performed based on signal strength criteria.

15. The apparatus of claim 11, wherein said reselection status message comprises a packet TBF release message.

16. A computer program product for providing reselection in a communication network, the computer program product comprising:
a machine-readable medium encoded with codes executable to:
establish at least one of a temporary block flow (TBF) downlink and a TBF uplink with a first cell;
determine that reselection to a second cell is to be performed; and
transmit a reselection status message to the first cell indicating the reselection.

17. A mobile device for providing reselection in a communication network, the mobile device comprising:
an antenna;
transceiver logic coupled to the antenna and configured to establish at least one of a temporary block flow (TBF) downlink and a TBF uplink with a first cell; and
processing logic configured to determine that reselection to a second cell is to be performed, and transmit a reselection status message to the first cell indicating the reselection.

18. A method for providing reselection in a communication network, the method comprising:
establishing at least one of a temporary block flow (TBF) downlink and a TBF uplink with a device;
receiving a reselection status message; and
terminating at least one of the TBF downlink and the TBF uplink in response to the reselection message.

19. The method of claim 18, further comprising releasing at least one of a temporary flow identifier (TFI) associated with the TBF downlink and a TFI associated with the TBF uplink to allow for reassignment.

20. The method of claim 18, wherein said receiving comprises receiving the reselection status message on at least one of an uplink packet associated control channel (PACCH) and the TBF uplink.

21. The method of claim 18, further comprising notifying the communication network of the reselection.

22. The method of claim 18, further comprising transmitting data over the TBF downlink to the device.

23. An apparatus for providing reselection in a communication network, the apparatus comprising:
a transceiver configured to establish at least one of a temporary block flow (TBF) downlink and a TBF uplink with a device and to receive a reselection status message; and
processing logic configured to terminate at least one of the TBF downlink and the TBF uplink in response to the reselection message.

24. The apparatus of claim 23, wherein said processing logic is configured to release at least one of a temporary flow identifier (TFI) associated with the TBF downlink and a TFI associated with the TBF uplink to allow for reassignment.

25. The apparatus of claim 23, wherein said processing logic is configured to receive the reselection status message on at least one of an uplink packet associated control channel (PACCH) and the TBF uplink.

26. The apparatus of claim 23, wherein said processing logic is configured to notify the communication network of the reselection.

27. The apparatus of claim 23, wherein said transceiver is configured to transmit data over the TBF downlink to the device.

28. An apparatus for providing reselection in a communication network, the apparatus comprising:
means for establishing at least one of a temporary block flow (TBF) downlink and a TBF uplink with a device;
means for receiving a reselection status message; and
means for terminating at least one of the TBF downlink and the TBF uplink in response to the reselection message.

29. The apparatus of claim 18, further comprising means for releasing at least one of a temporary flow identifier (TFI) associated with the TBF downlink and a TFI associated with the TBF uplink to allow for reassignment.

30. The apparatus of claim 18, wherein said means for receiving comprises means for receiving the reselection status message on at least one of an uplink packet associated control channel (PACCH) and the TBF uplink.

31. The apparatus of claim 18, further comprising means for notifying the communication network of the reselection.

32. The apparatus of claim 18, further comprising means for transmitting data over the TBF downlink to the device.

33. A computer program product for providing reselection in a communication network, the computer program product comprising:
a machine-readable medium encoded with codes executable to:
establish at least one of a temporary block flow (TBF) downlink and a TBF uplink with a device;
receive a reselection status message; and
terminate at least one of the TBF downlink and the TBF uplink in response to the reselection message.

34. A base station for providing reselection in a communication network, the base station comprising:
an antenna;
a transceiver configured to establish at least one of a temporary block flow (TBF) downlink and a TBF uplink with a device and to receive a reselection status message; and
processing logic configured to terminate at least one of the TBF downlink and the TBF uplink in response to the reselection message.
